(19) United States
(12) Patent Application Publication
(10) Pub. No.: US 2016/0199862 A1
(43) Pub. Date: Jul. 14, 2016

(54) FOAM GUN

(71) Applicant: ALTACHEM NV, Deinze (BE)

(72) Inventors: Jean-Marie POPPE, Heule (BE); Lieven SICHIEN, Uitbergen (BE)

(73) Assignee: Altachem NV, Deinze (BE)

(21) Appl. No.: 14/913,019

(22) PCT Filed: Aug. 22, 2014
(86) PCT No.: PCT/EP2014/067931

§ 371 Date: Feb. 19, 2016

(30) Foreign Application Priority Data
Aug. 22, 2013 (DE) 20 2013 103 811.3

(51) Int. Cl. B05B 9/08; B05B 12/00

(52) U.S. Cl. CPC B05B 9/0894; B05B 12/002

(57) ABSTRACT

The invention relates to a foam gun, in particular for polyurethane foam, having a body and, fitted thereto, a handle with a triggering device, having a container holder and a fluid connection between said container holder and an outlet opening to which an interchangeable dispensing tip is attachable.

To facilitate the carrying along of dispensing tips, it is proposed within the framework of the invention that the handle be designed to accommodate at least one dispensing tip.

The handle may be hollow inside and serve to accommodate at least one dispensing tip, preferably several dispensing tips. This is insofar advantageous that the foam gun always includes spare dispensing tips, making it unnecessary to carry these along separately. The dispensing tips are moreover protected until needed from the frequently harsh general conditions prevailing at the place of use, in particular from contamination by chemicals that could trigger an unwanted reaction with the exiting polyurethane foam.

The invention relates to a foam gun, in particular for polyurethane foam, having a body and, fitted thereto, a handle with a triggering device, having a container holder and a fluid connection between said container holder and an outlet opening to which an interchangeable dispensing tip is attachable.

Polyurethane foam is used in many fields, in particular the building industry. It comes in the form of one-component polyurethane foam, which reacts with air moisture and then cures, and in the form of two-component polyurethane foam, in which two components react with each other to form the polyurethane foam, which then cures. Both sorts of polyurethane foam are applied with a foam gun.

A foam gun for two-component polyurethane foam is known from the US 2002/013200 A1. This has an inlet chamber for the polyurethane foam components, a mixing chamber with a static mixer for mixing the polyurethane foam components and a dispensing tip for applying the polyurethane foam. This dispensing tip is generally configured as a hollow elongate body, which tapers towards the front end. Depending on the relevant application requirements, the dispensing tip may also have other shapes. Since the polyurethane foam in the dispensing tip cures, the latter is configured as a disposable product that can be replaced. The same applies to the application of other products with foam guns.

It is therefore necessary to carry dispensing tips along with a foam gun, in order that these may be replaced if a dispensing tip is clogged.

The object of the invention consists in facilitating the carrying-along of dispensing tips.

This object is established according to the invention by designing the handle to accommodate at least one dispensing tip.

The handle may be hollow inside and serve to accommodate at least one dispensing tip, preferably several dispensing tips. This is insofar advantageous that the foam gun always includes spare dispensing tips, making it unnecessary to carry these along separately. The dispensing tips are moreover protected until needed from the frequently harsh general conditions prevailing at the place of use, in particular from contamination by chemicals that could trigger an unwanted reaction with the exiting polyurethane foam.

A refinement of the invention consists in that the free end of the handle is configured as a removable cap, which, on its inside, has at least one holder for a dispensing tip.

It goes without saying that other configurations for accommodating dispensing tips in the handle are possible.

In this context it is advantageous for the at least one holder to be configured as a conical projection on the inside of the cap.

The dispensing tip can then be pushed, with its large opening, onto this conical projection.

A preferred embodiment of the invention consists in that the cap has a projection configured to engage a matching depression on the inside of the handle.

An embodiment of the invention is explained below by reference to the drawings.

The drawing in

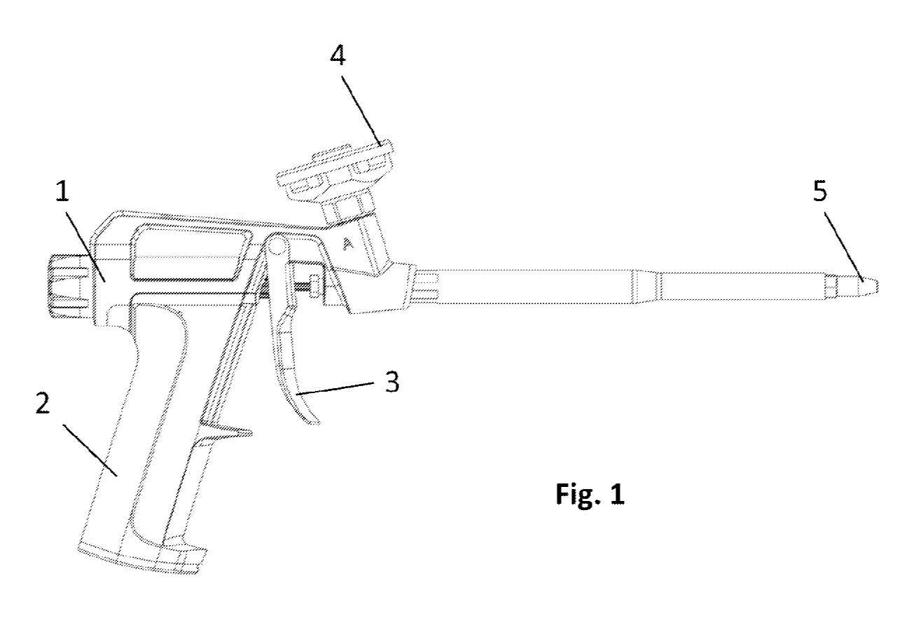

FIG. 1 is a side view of a foam gun according to the invention.

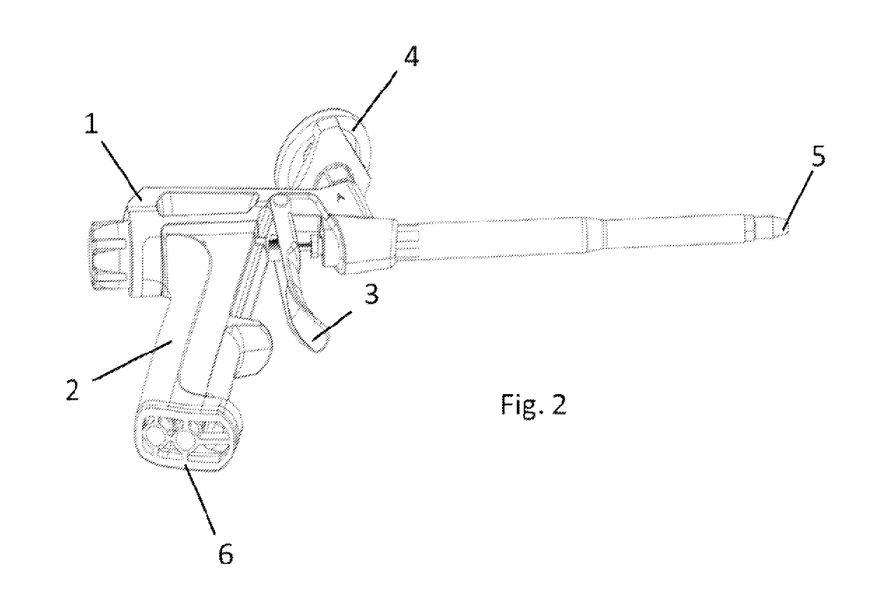

FIG. 2 is a perspective view of a foam gun according to the invention and shows the underside of the lid.

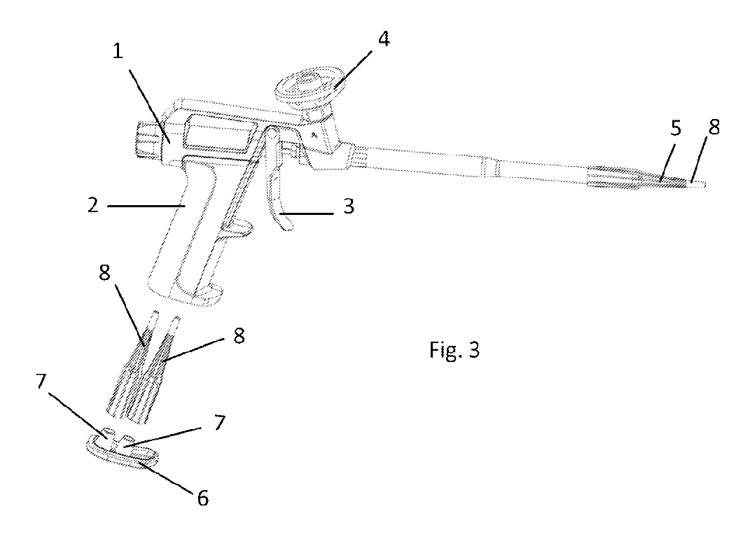

FIG. 3 is a side view of a foam gun according to the invention, with the cap off.

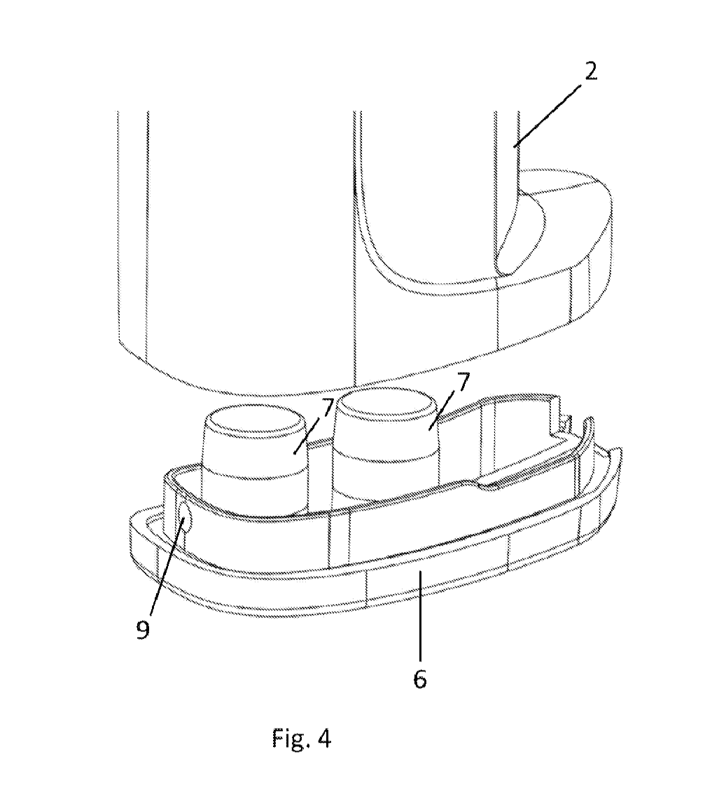

FIGS. 4 to 7 show details of the cap and of the holder for the dispensing tips.

As is evident from FIG. 1, the foam gun has a body (1) and, fitted thereto, a handle (2) with a triggering device (3), a container holder (4) and a fluid connection between the container holder (4) and an outlet opening (5), to which an interchangeable dispensing tip is attachable in order, for example, to obtain a finer application breadth than is possible with the outlet opening (5).

The handle (2) of the device according to the invention is designed to accommodate at least one dispensing tip. To this end, the handle (2) is hollow and the free end of the handle (2) is configured as a removable cap (6). The cap (6) may be attached to the handle (2) by means of a snap-in connection, for example. On its inside, the cap (6) has at least one holder (7) for a dispensing tip (8). In the example shown in FIGS. 2 and 3, it has two holders (7) for dispensing tips (8). This/these holder(s) (7) is/are configured as conical projections, onto which the larger end of the dispensing tips (8) can be pushed, on the inside of the cap (6).

As shown in FIG. 3, the cap (6) can be removed from the handle (2). The dispensing tips (8) attached to the cap (6) are removed by pulling them off the respective holder (7). The dispensing tip (8) fitted on the outlet opening (5) can then be removed, for example if it is clogged, and a new dispensing tip (8) pushed onto the outlet opening. The cap (6) is then snapped onto the handle (2) again to protect the remaining dispensing tip (8).

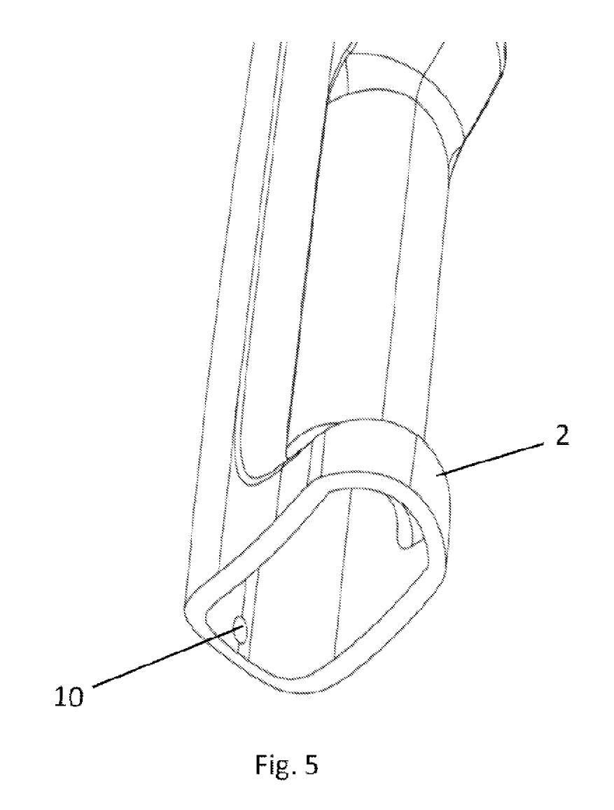

FIGS. 4 to 7 show detailed views of the cap (6) and the holder (7) for the dispensing tips (8). In each of FIGS. 4 and 5, the cap (6) has been removed from the handle (2). It can be seen in FIG. 4 that, on the inside of the cap (6), a projection (9) is provided for latching the cap onto the handle (2). The holders (7) for the dispensing tips (8) are also easy to recognize, onto which the dispensing tips (8) are pushed in such a way that, when the cap (6) has been closed, they are parallel to the longitudinal axis of the handle (2).

As is evident from FIG. 5, the handle (2) has, on its inside, a depression (10) which is engineered such that it can accommodate the projection (9). The projection (9) and the depression (10) may be shaped arbitrarily. It is also possible for the projection (9) to be on the inside of the handle (2) and the depression (10) on the inside of the cap (6).

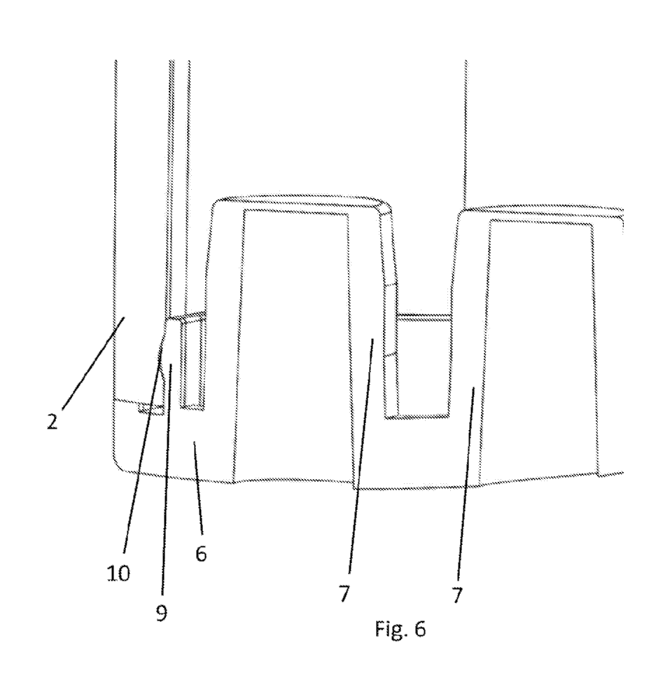

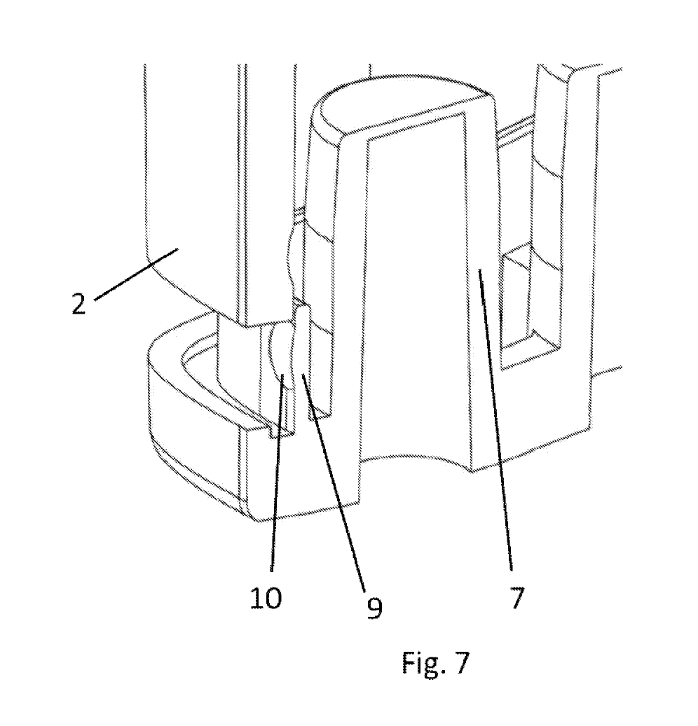

FIGS. 6 and 7 show how the projection (9) and the depression (10) interlock when the cap (6) is on the handle (2), preventing the cap (6) from being detached from the handle (2) unless a force greater than that of the form fit is applied.

1-4. (canceled)

5: Foam gun, in particular for polyurethane foam, having a body (1) and, fitted thereto, a handle (2) with a triggering device (3), having a container holder (4) and a fluid connection between said container holder (4) and an outlet opening (5) to which an interchangeable dispensing tip (8) is attachable, wherein the handle (2) is designed to accommodate at least one dispensing tip (8) and the free end of the handle (2) is designed as a cap (6) which, on its inside, has at least one holder (7) for a dispensing tip (8).

6: Foam gun according to claim 5, wherein at least one holder (8) is configured as a conical projection on the inside of the cap (6).

7: Foam gun according to claim 5, wherein the cap (6) has a projection (9) configured to engage a matching depression (10) on the inside of the handle (2).
